(19) United States
(12) Patent Application Publication
(10) Pub. No.: US 2025/0173535 A1
(43) Pub. Date: May 29, 2025

(54) IMAGE PROCESSING APPARATUS AND IMAGE PROCESSING METHOD

(71) Applicant: CANON KABUSHIKI KAISHA, Tokyo (JP)

(72) Inventors: HARUNA YAMAZAKI, Chiba (JP); TATSUYA MURAO, Kanagawa (JP); HIRONORI NAKAMURA, Kanagawa (JP)

(21) Appl. No.: 18/953,249

(22) Filed: Nov. 20, 2024

(30) Foreign Application Priority Data
Nov. 29, 2023 (JP) 2023-202192

(51) Int. Cl. G06K 15/02; G06K 15/12

(52) U.S. Cl. CPC G06K 15/1856; G06K 15/129; G06K 15/1878; G06K 2215/0094; G06K 2215/101

(57) ABSTRACT

An image processing apparatus includes an alpha blending unit configured to perform alpha blending of a first image obtained through first head shading on a band image which is an image in units of band and a second image obtained through second head shading on the first image. The alpha blending unit switches a coefficient for the alpha blending for each line of the band image.

### CROSS-REFERENCE TO PRIORITY APPLICATION

This application claims the benefit of Japanese Patent Application No. 2023-202192, filed Nov. 29, 2023, which is hereby incorporated by reference herein in its entirety.

### BACKGROUND OF THE INVENTION

### Field of the Invention

The present invention relates to an image processing technique.

### Description of the Related Art

A recording head used in an ink jet recording apparatus may involve a variation in ejection characteristics (ejection amount, ejection direction, and the like) among a plurality of nozzles due to manufacturing variations or the like. Since such a variation leads to density unevenness of a recorded image, there has been known a head shading (HS) technique used in an inkjet printer for calibration of ejection characteristics as described in Japanese Patent Laid-Open No. 10-13674. With regard to an inkjet printer that performs full-color printing, a printed image with color inconsistency suppressed is required to be obtained through suppression of the variation in the ejection characteristics through correction known as color shading with which color tones of a plurality of colors are calibrated as described in Japanese Patent Laid-Open No. 2014-111387, in addition to the HS used for correction of a single color.

With regard to a serial printer, the HS may be required for a longitudinally connected head (configured with recording heads longitudinally connected) or the like provided for an increase in length of a nozzle array for the sake of an increase in speed. A case where an amount of correction using the HS is changed in one nozzle array and multi-pass printing is performed will be considered. In such a case, a system in which the HS is performed on multi-valued data before quantization may have a feature enabling correction with fine gradation. Still, a pixel of a certain line with image data and a position of a nozzle for the ejection of the pixel may not be in one to-one relationship. Therefore, as described in Japanese Patent Laid-Open No. 2011-25685, correction is further required based on the HS for nozzle arrays and contribution rate of each of the nozzle arrays.

For such correction, table conversion processing based on Look Up Table (LUT) corresponding to the ejection characteristics of the nozzles of the recording head is employed. In order to achieve precise association with the HS in an inkjet apparatus including the longitudinally connected head, nozzles used for respective passes in multi-pass need to be associated with different HS tables. In view of this, measures such as correcting the HS table by overlapping a plurality of tables for the same pixel and adjusting the effectiveness of the correction in units of lines are required. Unfortunately, such measures lead to low and compromised efficiency. Furthermore, since a plurality of tables are arranged, a circuit scale and processing load impact are large. Thus, such measures are difficult to take.

In addition, in an inkjet apparatus including a line head that uses a large number of nozzle arrays corresponding to a page width for image formation, it is necessary to provide HS tables for positions of nozzles when executing page processing, and to switch among the HS tables and use the HS table depending on the position of the image to be formed. Thus, when an image of one page is processed, the switching among the HS tables needs to be performed for a number of times, and switching processing time and a memory band at the time of transfer affect the performance and the circuit scale. The performance can be improved by reducing the number of times the HS table is switched, but the reduction compromises the accuracy of the correction by the HS. Thus, there has been a demand for improvement in performance of the correction by the HS while reducing the number of times the table is switched.

### SUMMARY OF THE INVENTION

The present invention provides a technique for suppressing degradation in processing performance and an increase in the scale of a configuration to be implemented for head shading for an image.

According to the first aspect of the present invention, there is provided an image processing apparatus comprising an alpha blending unit configured to perform alpha blending of a first image obtained through first head shading on a band image which is an image in units of band and a second image obtained through second head shading on the first image, wherein the alpha blending unit switches a coefficient for the alpha blending for each line of the band image.

According to the second aspect of the present invention, there is provided an image processing apparatus comprising an alpha blending unit configured to perform alpha blending of first images that are images for respective print passes in a band image that is an image in units of band, and a second image obtained by performing head shading on the first image, wherein the alpha blending unit switches a coefficient for the alpha blending for each of the first images.

According to the third aspect of the present invention, there is provided an image processing method performed by an image processing apparatus, the method comprising: performing alpha blending of a first image obtained through first head shading on a band image which is an image in units of band and a second image obtained through second head shading on the first image; and switching a coefficient for the alpha blending for each line of the band image.

According to the fourth aspect of the present invention, there is provided an image processing method performed by an image processing apparatus, the method comprising: performing alpha blending of first images that are images for respective print passes in a band image that is an image in units of band, and a second image obtained by performing head shading on the first image; and switching a coefficient for the alpha blending for each of the first images.

Further features of the present invention will become apparent from the following description of exemplary embodiments with reference to the attached drawings.

### Solution to Problem

An aspect of the present invention includes an alpha blending unit configured to perform alpha blending of a first image obtained through first head shading on a band image which is an image in units of band and a second image obtained through second head shading on the first image, wherein the alpha blending unit switches a coefficient for the alpha blending for each line of the band image.

### Effect of the Invention

The present invention can provide a technique for suppressing degradation in processing performance and an increase in the scale of a configuration to be implemented for head shading for an image.

### BRIEF DESCRIPTION OF THE DRAWINGS

FIG. 1 is a block diagram illustrating a configuration example of a processing unit 201.

FIG. 2 is a block diagram illustrating a hardware configuration example of an inkjet printer 200.

FIG. 3 is a flowchart illustrating print processing for a print target image executed by the inkjet printer 200.

FIG. 4 is a diagram illustrating an example where the print target image is divided into a plurality of band images.

FIG. 5 is a diagram illustrating a configuration example of a recording processing unit 205.

FIG. 6 is a diagram illustrating correspondence relationship between a recording head 503 and the print target image.

FIG. 7A is a diagram illustrating an example a recorded image under a variation among ejection nozzles 600.

FIG. 7B is a diagram illustrating an example a recorded image under a variation among ejection nozzles 600.

FIG. 8A is a diagram illustrating an example of a result of recording an image with increased/lowered density through HS.

FIG. 8B is a diagram illustrating an example of a result of recording an image with increased/lowered density through HS.

FIG. 9 is a diagram illustrating a configuration example of an α coefficient table 108.

FIG. 10 is a diagram illustrating a configuration example of the processing unit 205.

FIG. 11 is a diagram illustrating a correspondence relationship between a recording head 1001 and the print target image.

FIG. 12A is a diagram illustrating a relationship between a position of a nozzle array 1002 and a printing medium P, when printing is performed on the printing medium P by four pass printing.

FIG. 12B is a diagram illustrating a relationship between a position of the nozzle array 1002 and the printing medium P, when printing is performed on the printing medium P by four pass printing.

FIG. 12C is a diagram illustrating a relationship between a position of the nozzle array 1002 and the printing medium P, when printing is performed on the printing medium P by four pass printing.

FIG. 13 is a block diagram illustrating a configuration example of the processing unit 201.

FIG. 14 is a flowchart illustrating print processing for a print target image executed by the inkjet printer 200.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

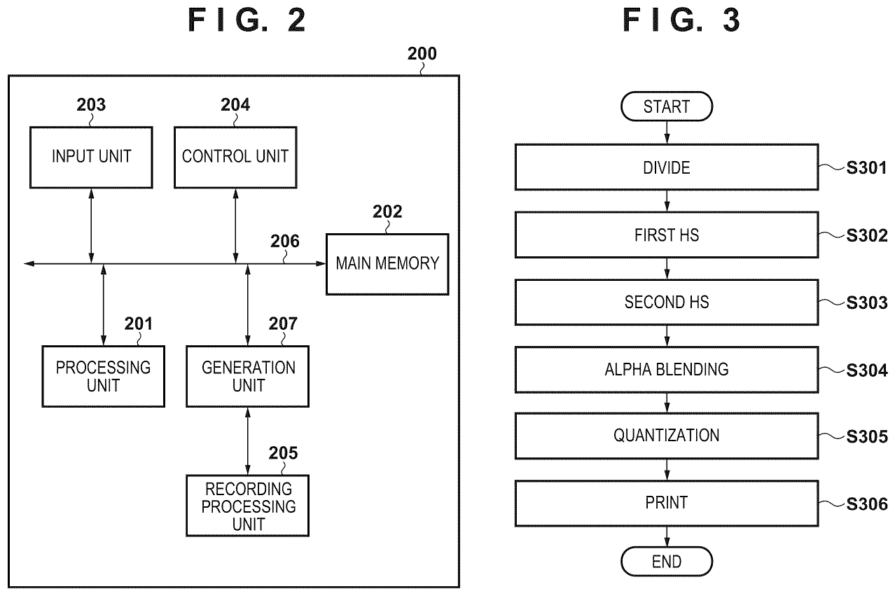

In the present embodiment, a case where an inkjet printer is used as a recording apparatus will be described. Next, a hardware configuration example of an inkjet printer 200 according to the present embodiment will be described with reference to a block diagram in FIG. 2. Note that FIG. 2 is a diagram illustrating a configuration related to the description below, and is not a diagram illustrating the entire configuration of the inkjet printer.

An input unit 203 performs data communication with an external apparatus. For example, the input unit 203 receives a multi-valued image to be printed (print target image) transmitted from an external apparatus and stores the print target image in a main memory 202.

A control unit 204 includes one or more processors and one or more memories, and executes various types of processing using a computer program and data stored in the main memory 202. With this configuration, the control unit 204 entirely controls the operation of the inkjet printer 200, and executes or controls various types of processing described as being executed by the inkjet printer 200.

The main memory 202 includes an area for storing computer programs and data loaded from a memory of the control unit 204, and an area for storing data received by the input unit 203 from an external apparatus. Furthermore, the main memory 202 has a work area used when the control unit 204, a processing unit 201, and a generation unit 207 execute various types of processing. As described above, the main memory 202 can appropriately provide various types of areas.

The processing unit 201 performs head shading (HS) on a print target image input as an input image. In the present embodiment, a case will be described in which the “print target image” is a CMYK image with which each pixel having a pixel value of cyan (C), a pixel value of magenta (M), a pixel value of yellow (Y), and a pixel value of black (K).

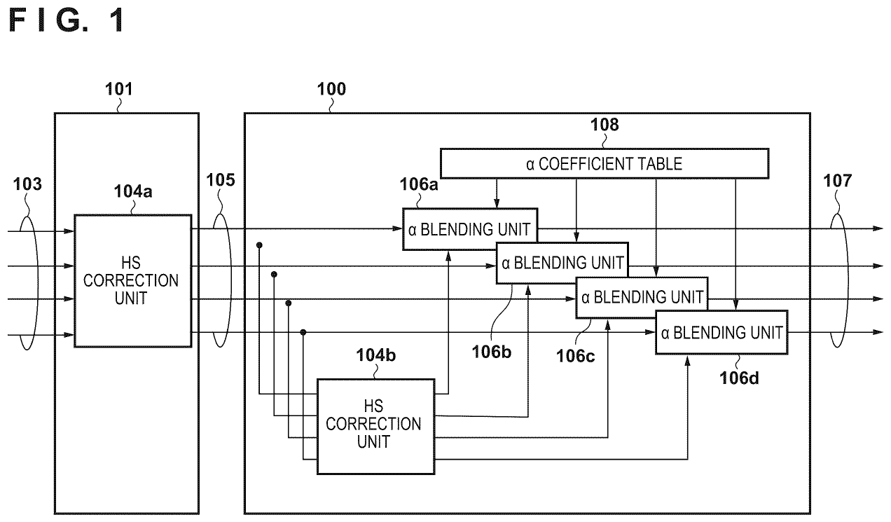

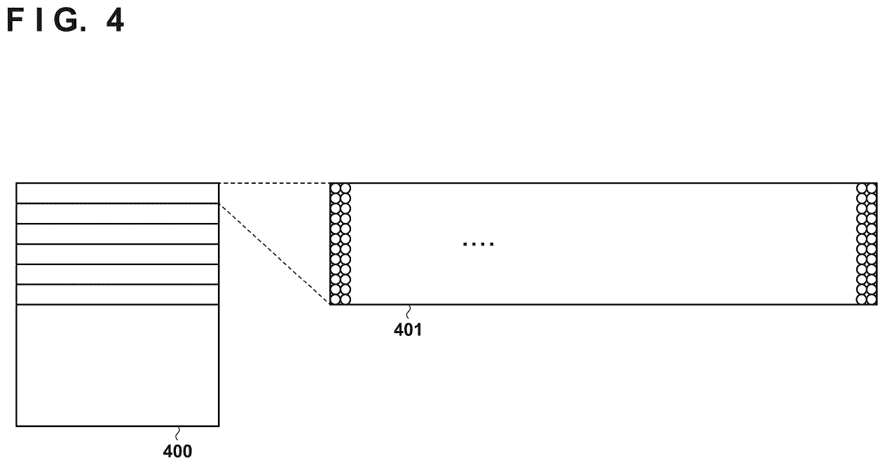

A configuration example of the processing unit 201 will be described with reference to a block diagram in FIG. 1. As illustrated in FIG. 1, the processing unit 201 includes a processing unit 101 and a processing unit 100. The control unit 204 divides the print target image into a plurality of bands (band images) and stores the band images in the main memory 202. Then, the control unit 204 controls DMAC to transfer the band image from the main memory 202 to the processing unit 201. Note that a method of transferring the band image stored in the main memory 202 to the processing unit 201 is not limited to a specific method. FIG. 4 illustrates an example where a print target image is divided into a plurality of band images. In FIG. 4, a print target image 400 is divided in units of band images 400 (band units), which are horizontally long rectangular images. However, the method of dividing the print target image is not limited to a specific method, and for example, the print target image may be divided in a grid pattern.

An image (C image) formed by a C pixel value of each pixel of the band image, an image (M image) formed by an M pixel value of each pixel of the band image, an image (Y image) formed by a Y pixel value of each pixel of the band image, and an image (K image) formed by a K pixel value of each pixel of the band image are input to an HS correction unit 104a via a signal line group 103. The HS correction unit 104a performs HS (first HS) on each of the C image, the M image, the Y image, and the K image to generate a C′ image, an M′ image, a Y′ image, and a K′image. For example, the HS correction unit 104a generates the C′ image corresponding to the C image using an HS table Cmin which is a one dimensional LUT for converting the pixel values in the C image into the pixel values in the C′ image. Similarly, the HS correction unit 104a generates an M′ image corresponding to the M image using an HS table Mmin which is a one dimensional LUT for converting the pixel values in the M image into the pixel values in the M′ image. Similarly, the HS correction unit 104a generates a Y′ image corresponding to the Y image using an HS table Ymin which is a one dimensional LUT for converting the pixel values in the Y image into the pixel values in the Y′ image. Similarly, the HS correction unit 104a generates a K′ image corresponding to the K image using an HS table Kmin which is a one dimensional LUT for converting the pixel values in the K image into the pixel values in the K′image. The first HS is HS correction performed when the density of a recorded image becomes low due to a variation among the nozzles of the recording head of the inkjet printer 200. Then, the HS correction unit 104a outputs the C′ image, the M′ image, the Y′ image, and the K′ image via a signal line group 105.

The C′ image, the M′ image, the Y′ image, and the K′ image are input to an HS correction unit 104b via the signal line group 105. The HS correction unit 104b performs second HS, different from the first HS, on each of the C′ image, the M′ image, the Y′ image, and the K′image to generate a C″ image, an M″ image, a Y″ image, and a K″ image. For example, the HS correction unit 104b generates the C″ image corresponding to the C′ image using an HS table Cmax which is a one dimensional LUT for converting the pixel values in the C′ image into the pixel values in the C″ image. Similarly, the HS correction unit 104b generates an M″ image corresponding to the M′ image using an HS table Mmax which is a one dimensional LUT for converting the pixel values in the M′image into the pixel values in the M″ image. Similarly, the HS correction unit 104b generates a Y″ image corresponding to the Y′ image using an HS table Ymax which is a one dimensional LUT for converting the pixel values in the Y′ image into the pixel values in the Y″ image. Similarly, the HS correction unit 104b generates a K″ image corresponding to the K′ image using an HS table Kmax which is a one dimensional LUT for converting the pixel values in the K′image into the pixel values in the K″ image. The second HS is HS correction performed when the density of a recorded image becomes high due to a variation among the nozzles of the recording head of the inkjet printer 200.

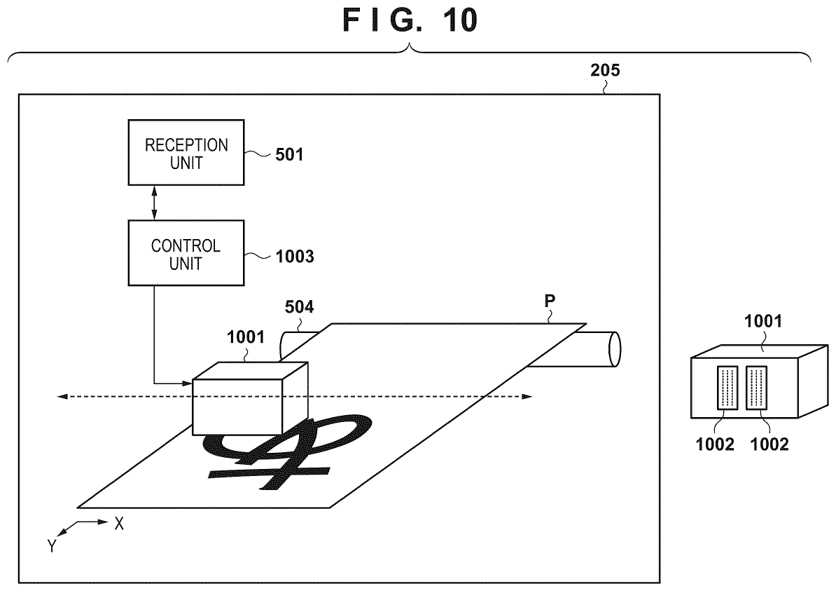

In an α coefficient table 108, for each line in the band image, α coefficient (α value) used in alpha blending for the line is registered for each component (color component). FIG. 9 illustrates a configuration example of the α coefficient table 108. In the α coefficient table 108 illustrated in FIG. 9, the coefficient (α value) used in alpha blending for a band image having 12 lines are registered for each line and each component. For example, in the α coefficient table 108, for the line with the line number=2, “26” is registered as the α value for a component C0 (C), “31” is registered as the α value for a component C1 (M), “10” is registered as the α value for a component C2 (Y), and “17” is registered as the α value of a component C3 (K).

An α blending unit 106a generates the processed C image by performing alpha blending for each line of the C′ image using the line, the corresponding line corresponding to the line in the C″ image, and the α value of the component C0 (C) corresponding to the line number of the line in the α coefficient table 108.

Here, the pixel value of the pixel of interest in the line of interest of the C′ image is defined as P1, the pixel value of the corresponding pixel of interest corresponding to the pixel of interest in the C″ image is defined as P2, and the α value of the component C0 (C) corresponding to the line number of the line of interest in the α coefficient table 108 is defined as α1. Under such definition, the α blending unit 106a obtains the pixel value P3 of the pixel corresponding to the pixel of interest in the processed C image as P3=α1×P1+(1−α1)×P2.

Similarly, an α blending unit 106b generates a processed M image by performing alpha blending for each line of the M′ image using the line, the corresponding line corresponding to the line in the M″ image, and the α value of the component C1 (M) corresponding to the line number of the line in the α coefficient table 108.

Similarly, an α blending unit 106c generates a processed Y image by performing alpha blending for each line of the Y′ image using the line, the corresponding line corresponding to the line in the Y″ image, and the α value of the component C2 (Y) corresponding to the line number of the line in the α coefficient table 108.

Similarly, an α blending unit 106d generates a processed K image by performing alpha blending for each line of the K′image using the line, the corresponding line corresponding to the line in the K″ image, and the α value of the component C3 (K) corresponding to the line number of the line in the α coefficient table 108.

As described above, the processing unit 201 switches and uses the coefficient used for the alpha blending from the α coefficient table 108, for each line and component in the band image. More specifically, in the present embodiment, the processing unit 201 acquires the corresponding α value from the α coefficient table 108 by using, as arguments, the line number of the processing target line in the band image and the processing target component in the line. Still, the method of switching the α value for each line and each component in the band image is not limited to that using the α coefficient table 108. For example, the processing unit 201 may hold, for each component, a function representing the relationship between the line position and the α value in the band image, and acquire the α value corresponding to the processing target line position from the function corresponding to the processing target component.

Then, the processing unit 100 outputs the processed images (the processed C image, the processed M image, the processed Y image, and the processed K image) via a signal line group 107. The control unit 204 controls the DMAC to transfer the processed image to the main memory 202.

The processing unit 201 executes quantization processing such as dither processing and error diffusion processing on the processed images (the processed C image, the processed M image, the processed Y image, and the processed K image) transferred to the main memory 202 to convert the processed images into binary data with “1” indicating record (eject ink) and “0” indicating do not record (do not eject ink). Then, the processing unit 201 stores the binary data in the main memory 202 as recording data.

The generation unit 207 reads data of each pixel in the recording data stored in the main memory 202 in a predetermined order, associates the data with each nozzle of the recording head of the recording processing unit 205, and supplies the data to the recording processing unit 205.

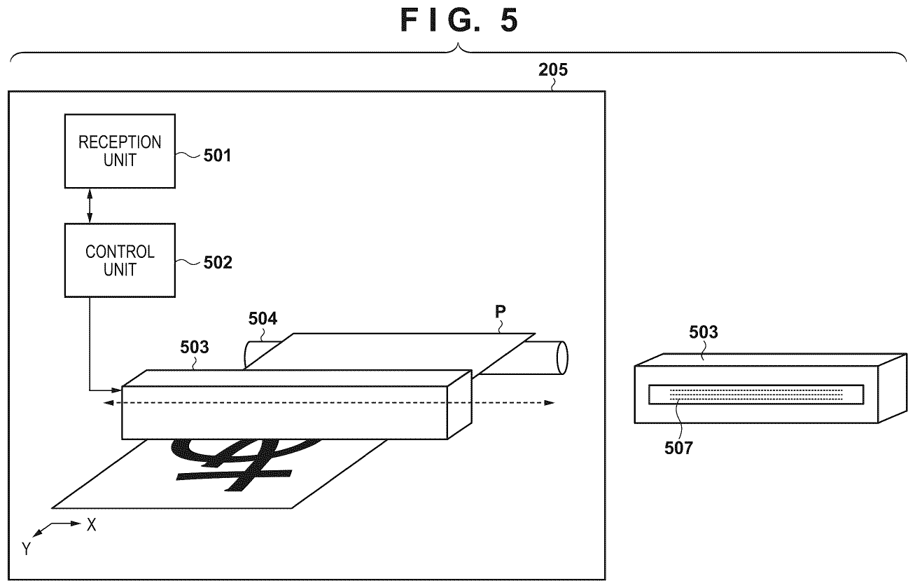

As illustrated in FIG. 5, the recording processing unit 205 includes a recording head 503 provided with nozzle arrays 507 as many as the number of corresponding ink colors, each array having arranged thereon a plurality of nozzles that eject ink as droplets, a conveyance mechanism 504 configured to execute a conveyance operation for a printing medium P, and the like. In the present embodiment, the nozzle array 507 has a length corresponding to a region in an X direction (a direction orthogonal to a conveyance direction Y of the printing medium P) in which printing can be performed on the printing medium P.

A reception unit 501 receives the recording data supplied from the generation unit 207. A control unit 502 performs drive control of the recording head 503 and the conveyance mechanism 504 in accordance with the recording data, thereby printing images and characters on the printing medium P and conveying the printing medium P in the conveyance direction Y.

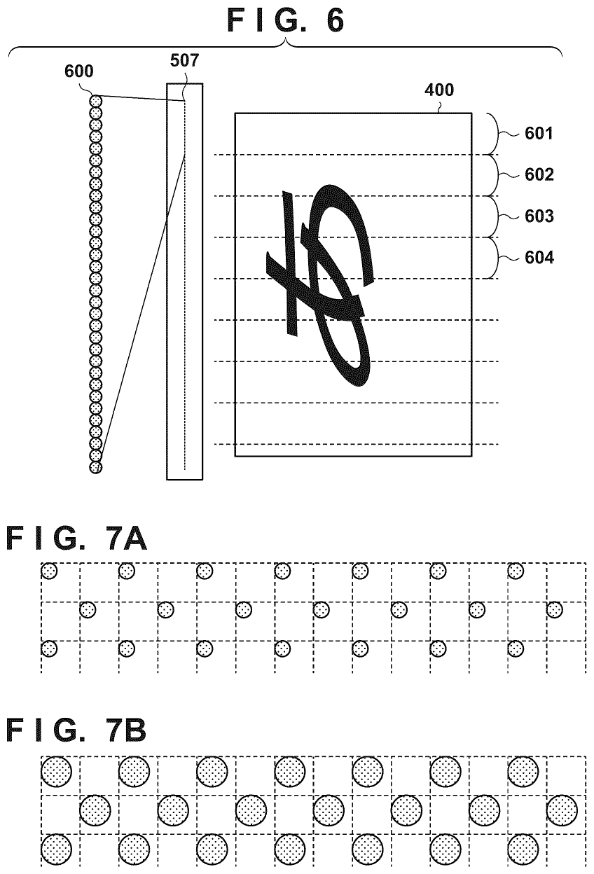

Next, correspondence relationship between the recording head 503 and the print target image will be described with reference to FIG. 6. The nozzle array 507 is an aggregate of ejection nozzles 600 in units of single dot. In FIG. 6, only one array is illustrated for the sake of simplification. In the case of color printing, a configuration may be employed including multiple nozzle arrays corresponding to respective ink colors such as C, M, Y, and K. In such a case, each pixel in the print target image 400 is associated in advance with a nozzle of the recording head 503 used for recording of the pixel. Since the print target image 400 is processed in units of band, an image of one page is divided into a plurality of bands such as a band 601, a band 602, a band 603, and a band 604. For the HS for the band 601, the LUT of the region in the nozzle array 507 corresponding to the band 601 is used. For the HS for the band 602, the LUT of the region, of the nozzle array 507, corresponding to the band 602 is used. By thus performing the HS according to the band, a recording result can be obtained with small color unevenness due to ejection variation.

The input unit 203, the control unit 204, the main memory 202, the processing unit 201, and the generation unit 207 are all connected to a system bus 206.

Now, the HS will be described. In order to accurately adjust the variation for each nozzle of the ejection nozzles 600, the HS corresponding to the nozzle needs to be performed for each pixel. In the present embodiment, since the band image has 12 lines, as illustrated in FIG. 9, 12 α values (HS adjustment parameters) equal to the number of lines are required for one component.

FIGS. 7A and 7B illustrate examples of images recorded with a variation among the ejection nozzles 600. Each rectangular region is a recording region of one pixel in the printing medium, and a circle in the rectangular region is a dot as a result of recording on the printing medium using an ink droplet. FIGS. 7A and 7B illustrate states in which the size of dots is different due to a variation among the ejection nozzles 600. As illustrated in the FIG. 7A, a small dot leads to exposure of a large portion (white) with no dot on the printing medium, resulting in low density of the recorded image on the printing medium. On the other hand, as illustrated in the 7B, a large dot leads to exposure of a small portion (white) with no dot on the print medium, resulting in high density of the recorded image on the printing medium.

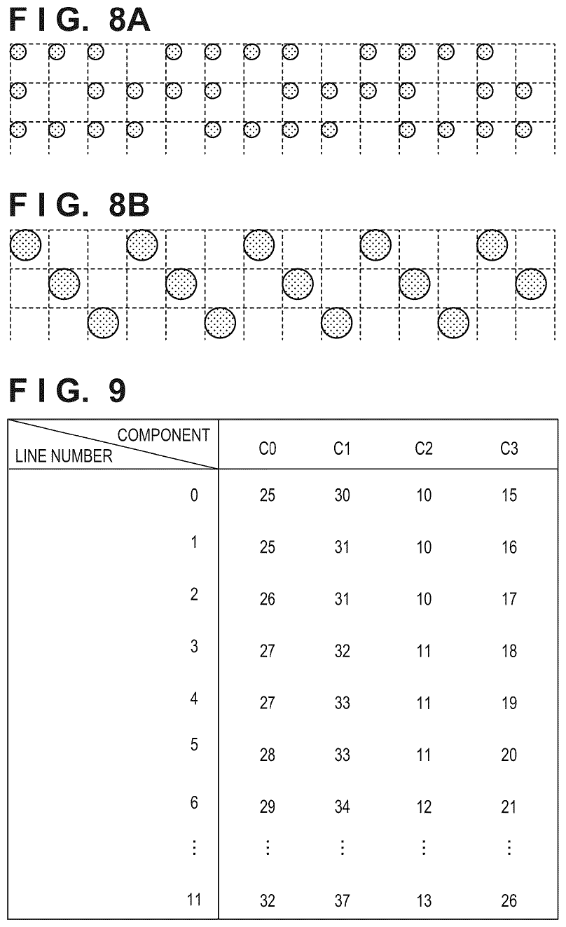

Assuming that FIGS. 7A and 7B both illustrate the result of recording an image with a density of 50% without performing the HS, FIGS. 8A and 8B illustrate the results of recording images respectively with higher and lower densities with the HS performed.

When a small dot is recorded as illustrated in FIG. 7A, the HS is performed to correct the image so as to obtain an image with a density of about 80%. On the other hand, when a large dot is recorded as illustrated in FIG. 7B, the HS is performed to correct the image so as to obtain an image with a density of about 33%. When a dot pattern is formed by quantizing the pixel values of the HS-processed image, patterns different from each other in thinning amount depending on the size of the dots are formed as illustrated in FIGS. 8A and 8B. FIG. 8A illustrates a dot pattern formed based on an image for which the HS has been performed to correct the image so as to obtain an image having a density of about 80%. FIG. 8B illustrates a dot pattern formed based on an image for which the HS has been performed to correct the image so as to obtain an image having a density of about 33%. Exaggerated examples are illustrated in FIGS. 8A and 8B for the sake of description. The quantization pattern and the correction amount related to the density are not limited to the examples. The HS of the present embodiment is for performing correction based on a criterion such as the size of the dot.

In the present embodiment, the minimum size (or a size smaller than the minimum size) among the sizes of the dots of the ink droplets ejected from the nozzles corresponding to the band image is measured/acquired in advance (such as, for example, at the time of shipment of the inkjet printer 200 from a factory) as a size S1. Then, based on the size S1, the one dimensional LUT (Cmin, Mmin, Ymin, Kmin) for correcting (HS correction) the “image with normal density” to the “image with density higher than the density of the image with normal density recorded without HS” is generated and registered in the inkjet printer 200. Therefore, the first HS which is the HS using such an LUT is processing of correcting the “image with normal density” to the “image with density higher than the density of the image with normal density recorded without HS”.

In the present embodiment, the maximum size (or a size larger than the maximum size) among the sizes of the dots of the ink droplets ejected from the nozzles corresponding to the band image is measured/acquired in advance (such as, for example, at the time of shipment of the inkjet printer 200 from a factory) as a size S2. Then, based on the size S2, the one dimensional LUT (Cmax, Mmax, Ymax, Kmax) for correcting (HS correction) the “image with normal density” to the “image with density lower than the density of the image with normal density recorded without HS” is generated and registered in the inkjet printer 200. Therefore, the second HS which is the HS using such an LUT is processing of correcting the “image with normal density” to the “image with density lower than the density of the image with normal density recorded without HS”.

When the recording data is generated for one band image, the processing unit 201 updates a parameter that needs to be changed for each band for the next processing. For example, the HS needs to be performed in accordance with the nozzles corresponding to the next band, and thus needs to be updated. Still, Cmin, Mmin, Ymin, Kmin, Cmax, Mmax, Ymax, and Kmax can be used without updating as long as the amount of HS correction in the band is between the first HS and the second HS. Therefore, the HS can be performed for the next band by updating the α coefficient table 108, whereby the parameter transfer amount can be reduced. Thus, the processing time and the amount of access to the main memory can be reduced. The α coefficient table 108 may or may not be updated depending on the case.

The print processing for the print target image executed by the inkjet printer 200 will be described with reference to the flowchart in FIG. 3. In step S301, the control unit 204 divides the print target image into a plurality of bands (band images), and controls the DMAC to transfer the band images to the processing unit 201. The processing in steps S302 to S306 is executed for each of the plurality of band images.

In step S302, the HS correction unit 104a performs the first HS on each of the C image, the M image, the Y image, and the K image to generate the C′ image, the M′ image, the Y′ image, and the K′ image.

In step S303, the HS correction unit 104b performs the second HS on each of the C′ image, the M′ image, the Y′ image, and the K′image to generate the C″ image, the M″ image, the Y″ image, and the K″ image.

In step S304, the α blending unit 106a generates the processed C image by performing alpha blending of the C′ image and the C″ image with reference to the a coefficient table 108. The α blending unit 106b generates the processed M image by performing alpha blending of the M′ image and the M″ image with reference to the a coefficient table 108. The α blending unit 106c generates the processed Y image by performing alpha blending of the Y′ image and the Y″ image with reference to the a coefficient table 108. The α blending unit 106d generates the processed K image by performing alpha blending of the K′image and the K″ image with reference to the a coefficient table 108.

In step S305, the processing unit 201 executes quantization processing such as dither processing and error diffusion processing on the processed images (the processed C image, the processed M image, the processed Y image, and the processed K image) to convert the processed images into binary data.

In step S306, the generation unit 207 reads data of each pixel in the recording data in a predetermined order, associates the data with each nozzle of the recording head of the recording processing unit 205, and supplies the data to the recording processing unit 205. The recording processing unit 205 performs drive control of the recording head 503 and the conveyance mechanism 504 in accordance with the recording data, thereby printing images and characters on the printing medium P and conveying the printing medium P in the conveyance direction Y.

### Second Embodiment

In the present embodiment, differences from the first embodiment will be described, and it is assumed that the present embodiment is similar to the first embodiment unless otherwise specified. In the first embodiment, a case of application to HS corresponding to an inkjet printer including a line head is described. In the present embodiment, a description will be given on a case of application to HS applicable to a printer that forms a recorded image on a printing medium by performing scanning with a recording head a plurality of times, such as a serial printer.

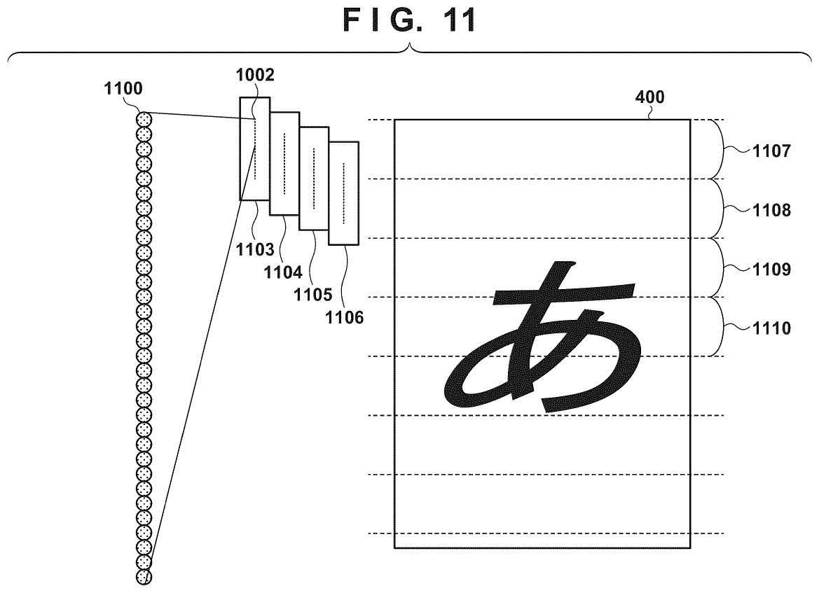

First, a configuration example of a processing unit 205 according to the present embodiment will be described with reference to FIG. 10. In FIG. 10, the same functional units as those illustrated in FIG. 5 are denoted by the same reference numerals as those illustrated in FIG. 5, and descriptions related to the functional units will be omitted or will be simply given.

The recording head 1001 is provided with nozzle arrays 1002 as many as the number of corresponding ink colors, each array having arranged thereon a plurality of nozzles that eject ink in a form of droplet. A control unit 1003 performs drive control of the recording head 1001 and the conveyance mechanism 504 in accordance with the recording data received by the reception unit 501, thereby printing images and characters on the printing medium P and conveying the printing medium P in the conveyance direction Y.

The processing unit 205 records an image and characters on the printing medium P by alternately repeating recording scan performed through movement in the X direction intersecting the nozzle arrangement direction (Y direction) while ejecting ink droplets from the nozzle array 1002, and a conveyance operation in which the printing medium P is conveyed in the Y-direction as far as a distance corresponding to the width of recording by the recording scan.

Next, correspondence relationship between the recording head 1001 and the print target image will be described with reference to FIG. 11. The nozzle array 1002 of the recording head 1001 is an aggregate of ejection nozzles 1100 in units of single dot. In FIG. 11, only one array is illustrated for the sake of simplification, but there may be a plurality of arrays. In the case of color printing, a configuration may be employed in which there are multiple rows of nozzles for different ink colors such as C, M, Y, and K. Each pixel in the print target image 400 is associated in advance with a nozzle of the recording head 1001 used for recording for the pixel. Since the print target image 400 is processed in units of band, an image of one page is divided into a plurality of bands such as a band 1107, a band 1108, a band 1109, and a band 1110.

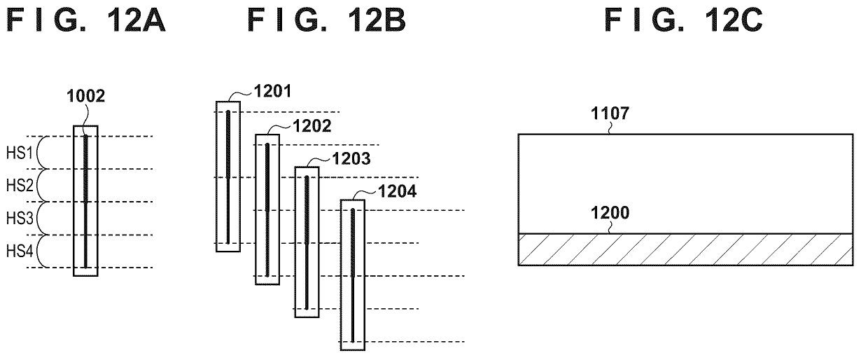

A nozzle array position 1103, a nozzle array position 1104, a nozzle array position 1105, and a nozzle array position 1106 indicate the positions of the nozzle array 1002 at the time of scanning of the printing medium P in the X direction by the recording head 1001. In the present embodiment, a description will be given using four pass printing as an example. Specifically, when the band 1107 is recorded on the printing medium P, scanning in the X direction is performed four times, through shifting in the Y direction by ¼ of the band height of the band 1107 at a time. While FIG. 11 illustrates a case where the length of the nozzle array 1002 and the band height of the bands 1107 to 1110 are the same, the length and the band height need not be the same. Unlike the first embodiment, in the present embodiment, when the band 1107 is processed, there are a plurality of regions corresponding to the band 1107 of the nozzle array 1002. Therefore, in the present embodiment, the HS needs to be performed by switching the LUT in accordance with the positions of the four recording scans that are the nozzle array position 1103 to the nozzle array position 1106. The relationship between the position of the nozzle array 1002 and the printing medium Pin a case of performing printing on the printing medium P by four pass printing will be described using the band 1107 as an example with reference to FIGS. 12A to 12C.

The relationship between the nozzle array 1002 and the HS will be described with reference to FIG. 12A. In FIG. 12A, the nozzle arrays 1002 are divided into four regions, and the nozzle array belonging to the uppermost region performs ink ejection based on an image subjected to HS performed with HS1 used as an LUT. The nozzle array belonging to the second region from the top performs ink ejection based on an image subjected to HS performed with HS2 used as an LUT, and the nozzle array belonging to the third region from the top performs ink ejection based on an image subjected to HS performed with HS3 used as an LUT. The nozzle array belonging to the lowermost region performs ink ejection based on an image subjected to HS performed with HS4 used as an LUT. With this configuration, it is possible to obtain a recorded image with small unevenness on the printing medium P.

In FIG. 12B, a nozzle array position 1201, a nozzle array position 1202, a nozzle array position 1203, and a nozzle array position 1204 indicate the relative positional relationship between the nozzle array 1002 and the band 1107 in a case where the printing medium P is scanned in the X direction by the recording head 1001.

The nozzle array position 1201 indicates the position of the nozzle array 1002 at the time of the first scanning operation, and the nozzle array position 1202 indicates the position of the nozzle array 1002 at the time of the second scanning operation. The nozzle array position 1203 indicates the position of the nozzle array 1002 at the time of the third scanning operation, and the nozzle array position 1204 indicates the position of the nozzle array 1002 at the time of the fourth scanning operation. Through the scanning performed four times, a recording region 1200 in the band 1107 is scanned by all the nozzles of the nozzle array 1002 scan, whereby an image is formed in the recording region 1200. In addition, when the total ejection amount to the recording region 1200 is defined as 100%, the ejection amount may be adjusted according to the corresponding printing pass, such as 40% for the nozzle array position 1201, 10% for the nozzle array position 1202, 10% for the nozzle array position 1203, and 40% for the nozzle array position 1204. When the HS is applied under a multi-value condition, since the recording region 1200 is one image, different HS values is difficult to reflect. On the other hand, the present embodiment is configured in such a manner that a result of applying HS1, a result of applying HS2, a result of applying HS3, and a result of applying HS4 can be reflected on the recording region 1200 with intensities of 40%, 10%, 10%, and 40%, respectively.

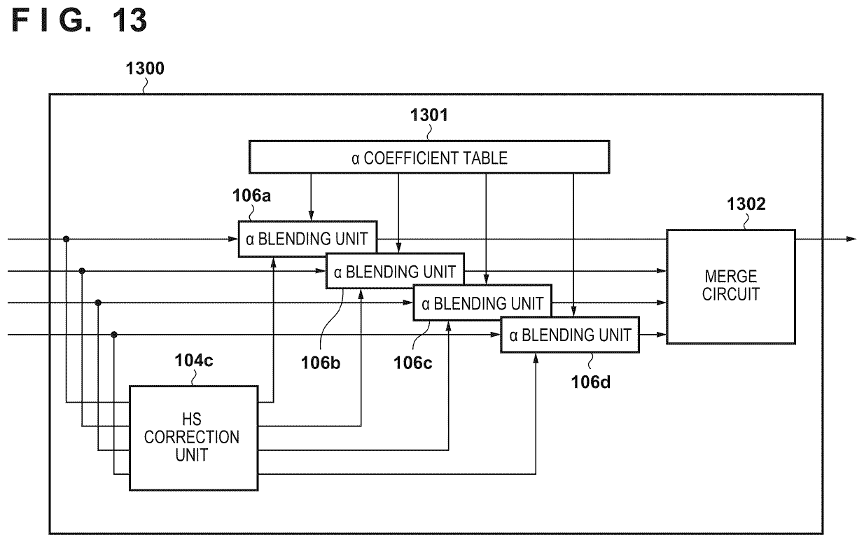

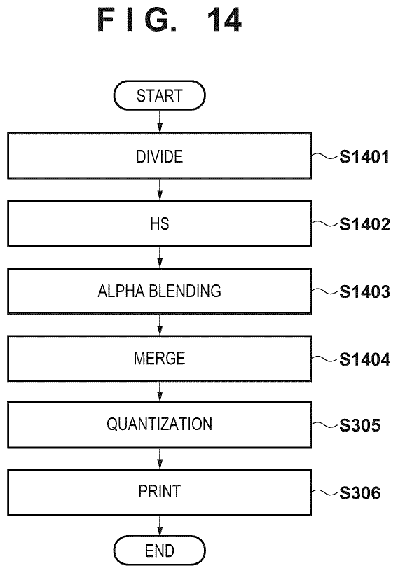

First, a configuration example of the processing unit 201 according to the present embodiment will be described, using a block diagram in FIG. 13. FIG. 13 illustrates a case where printing is performed on the printing medium P by four pass printing.

The control unit 204 divides an X (X=C, M, Y, K) image into a pass image R1 which is an image of a region in the X image to be printed in the first pass, a pass image R2 which is an image of a region in the X image to be printed in the second pass, a pass image R3 which is an image of a region in the X image to be printed in the third pass, and a pass image R4 which is an image of a region in the X image to be printed in the fourth pass. Then, the control unit 204 inputs the pass images R1 to R4 to the processing unit 201.

An HS correction unit 104c performs HS on each of the pass images R1 to R4 to generate pass images R′1 to R′4. For example, the HS correction unit 104c generates the pass image R′1 corresponding to the pass image R1 by using HS1 which is a one dimensional LUT for converting the pixel values in the pass image RI into the pixel values in the pass image R′1. Similarly, the HS correction unit 104c generates the pass image R′2 corresponding to the pass image R2 by using HS2 which is a one dimensional LUT for converting the pixel values in the pass image R2 into the pixel values in the pass image R′2. Similarly, the HS correction unit 104c generates the pass image R′3 corresponding to the pass image R3 by using HS3 which is a one dimensional LUT for converting the pixel values in the pass image R3 into the pixel values in the pass image R′3. Similarly, the HS correction unit 104c generates the pass image R′4 corresponding to the pass image R4 by using HS4 which is a one dimensional LUT for converting the pixel values in the pass image R4 into the pixel values in the pass image R4′.

In an α coefficient table 1301, for each pass image in the band image, a coefficient (α value) used in alpha blending for the pass image is registered for each component (color component).

The α blending unit 106a performs alpha blending using the pass image R1, the pass image R′1, and an α value (for example, 0.4) corresponding to the pass image R1 and a component X in the α coefficient table 1301 to generate a processed image R″1.

Here, the pixel value of the pixel of interest in the pass image R1 is defined as P1, the pixel value of the corresponding pixel of interest corresponding to the pixel of interest in the pass image R′1 is defined as P2, and the α value corresponding to the pass image R1 and the component X in the α coefficient table 1301 is defined as a1. Under such definition, the α blending unit 106a obtains the pixel value P3 of the pixel corresponding to the pixel of interest in the processed image R″1 as P3 =a1 x P1 + (1-a1)×P2.

The α blending unit 106b performs alpha blending using the pass image R2, the pass image R′2, and an α value (for example, 0.1) corresponding to the pass image R2 and a component X in the α coefficient table 1301 to generate a processed image R″2.

The α blending unit 106b performs alpha blending using the pass image R3, the pass image R′3, and an α value (for example, 0.1) corresponding to the pass image R3 and a component X in the α coefficient table 1301 to generate a processed image R″3.

The α blending unit 106d performs alpha blending using the pass image R4, the pass image R′4, and an α value (for example, 0.4) corresponding to the pass image R4 and a component X in the α coefficient table 1301 to generate a processed image R″4.

A merge circuit 1302 merges the processed images R1 to R″4 (arranges them according to the positional relationship of the corresponding pass images) to generate one image as a processed X image, and outputs the processed X image.

A processing unit 1300 performs the above operation for all the components (C, M, Y, and K) to generate and output the processed C image corresponding to the C image, the processed M image corresponding to the M image, the processed Y image corresponding to the Y image, and the processed K image corresponding to the K image. The operation performed by the inkjet printer 200 thereafter is similar to that in the first embodiment.

The print processing for the print target image executed by the inkjet printer 200 will be described with reference to the flowchart in FIG. 14. In the flowchart in FIG. 14, processing steps similar to the processing steps illustrated in FIG. 3 are provided with the same step numbers, and description of those processing steps is omitted. The processing in steps S1402 to S1404 is performed for each component for each of the plurality of band images.

In step S1401, the control unit 204 divides the print target image into a plurality of bands (band images). Then, the control unit 204 divides the X (X=C, M, Y, K) image into pass images R1 to R4. In step S1402, the HS correction unit 104c performs HS on each of the pass images R1 to R4 to generate the pass images R′1 to R′4.

In step S1403, the α blending unit 106a generates the processed image R″1 by performing alpha blending of the pass image R1 and the pass image R′1 with reference to the α coefficient table 1301. The α blending unit 106b generates the processed image R″2 by performing alpha blending of the pass image R2 and the pass image R′2 with reference to the α coefficient table 1301. The α blending unit 106c generates the processed image R″3 by performing alpha blending of the pass image R3 and the pass image R′3 with reference to the α coefficient table 1301. The α blending unit 106d generates the processed image R″4 by performing alpha blending of the pass image R4 and the pass image R′4 with reference to the α coefficient table 1301.

In step S1404, the merge circuit 1302 merges the processed images R1 to R″4 (arranges them according to the positional relationship of the corresponding pass images) to generate one image as the processed X image, and outputs the processed X image.

Note that a configuration in which the first embodiment and the second embodiment are switched and used is also conceivable. For example, the processing unit 201 may include a switching unit that switches the input destination of the band image to one of the processing unit 101 and the processing unit 1300, and a switching unit that switches the destination of output from the α blending units 106a to 106d to one of the main memory 202 and the merge circuit 1302.

While the processing unit 1300 executes the processing for all components in the present embodiment, the processing unit 1300 for processing the C image, the processing unit 1300 for processing the M image, the processing unit 1300 for processing the Y image, and the processing unit 1300 for processing the K image may be provided. In this case, by sequentially operating the processing units 1300 in a pipeline manner, it is possible to perform complicated HS on all the components.

Furthermore, in the description of the line head printer according to the first embodiment, an ink jet type line head is described, but the present invention is not limited to this, and may be applied to a light emitting diode (LED) printer using an LED instead of a laser as a light source. In an LED head of the LED printer, a plurality of fine LEDs are linearly arranged in parallel, and printing is performed by drawing an image on a photosensitive member using the LEDs as a light source. Such a configuration of the LED head involves a variation in amount of light among the LEDs. Thus, the variation in the amount of light in one line needs to be suppressed by performing shading for each pixel. In view of this, by applying the HS described in the first embodiment, it is possible to adjust the light amount of the LED instead of the ink ejection amount.

Functional units other than the α coefficient table 108 in the processing unit 201 and functional units other than the α coefficient table 1301 in the processing unit 1300 may be implemented by hardware or software.

The numerical values, processing timings, processing orders, processing entities, and data (information) acquiring method/transmission destination/transmission source/storage location, and the like that are used in each of the embodiments described above are referred to by way of an example for specific description, and are not intended to be limited to these examples.

Alternatively, some or all of the embodiments described above may be used in combination as appropriate. Alternatively, some or all of the embodiments described above may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
an alpha blending unit configured to perform alpha blending of a first image obtained through first head shading on a band image which is an image in units of band and a second image obtained through second head shading on the first image,
wherein the alpha blending unit switches a coefficient for the alpha blending for each line of the band image.

2. The image processing apparatus according to claim 1, further comprising a dividing unit configured to divide an input image into a plurality of the band images.

3. The image processing apparatus according to claim 1, further comprising a holding unit configured to hold the coefficient for the alpha blending for each line in the band image.

4. An image processing apparatus comprising:
an alpha blending unit configured to perform alpha blending of first images that are images for respective print passes in a band image that is an image in units of band, and a second image obtained by performing head shading on the first image,
wherein the alpha blending unit switches a coefficient for the alpha blending for each of the first images.

5. The image processing apparatus according to claim 4, further comprising a dividing unit configured to divide an input image into a plurality of the band images and divide the band images into the pass images for the respective printing passes.

6. The image processing apparatus according to claim 4, further comprising a holding unit configured to hold the coefficient for the alpha blending for each of the first images.

7. The image processing apparatus according to claim 1, further comprising a printing unit configured to perform printing based on an image obtained by the alpha blending performed by the alpha blending unit.

8. The image processing apparatus according to claim 7, wherein the printing unit performs the printing using a line head based on the image obtained by the alpha blending performed by the alpha blending unit.

9. The image processing apparatus according to claim 7, wherein the printing unit performs the printing using an LED head based on the image obtained by the alpha blending performed by the alpha blending unit.

10. An image processing method performed by an image processing apparatus, the method comprising:
performing alpha blending of a first image obtained through first head shading on a band image which is an image in units of band and a second image obtained through second head shading on the first image; and
switching a coefficient for the alpha blending for each line of the band image.

11. An image processing method performed by an image processing apparatus, the method comprising:
performing alpha blending of first images that are images for respective print passes in a band image that is an image in units of band, and a second image obtained by performing head shading on the first image; and
switching a coefficient for the alpha blending for each of the first images.
